(19) United States
(12) Patent Application Publication
(10) Pub. No.: US 2024/0274841 A1
(43) Pub. Date: Aug. 15, 2024

(54) SOLID OXIDE FUEL CELL

(71) Applicant: ATSUMITEC CO., LTD., Hamamatsu-shi, Shizuoka (JP)

(72) Inventors: Kazuhiro UCHIYAMA, Sendai-shi (JP); Naoki UCHIYAMA, Hamamatsu-shi (JP); Seigou NAKABAYASHI, Hamamatsu-shi (JP); Yasuyuki UCHIYAMA, Hamamatsu-shi (JP)

(21) Appl. No.: 18/681,938

(22) PCT Filed: Aug. 9, 2022
(86) PCT No.: PCT/JP2022/030358

§ 371 Date: Feb. 7, 2024

(30) Foreign Application Priority Data
Aug. 10, 2021 (JP) 2021-130472

(51) Int. Cl. H01M 8/04007; H01M 8/0273; H01M 8/0282; H01M 8/0432; H01M 8/04858; H01M 8/12

(52) U.S. Cl. CPC H01M 8/04037; H01M 8/0273; H01M 8/0282; H01M 8/04365; H01M 8/04947; H01M 2008/1293

(57) ABSTRACT

A solid oxide fuel cell includes an electrode including an electrolyte ceramic, and an anode electrode and a cathode electrode sandwiching the electrolyte ceramic from both sides, a metal frame located around the electrode so as to sandwich the electrode unit from both sides and physically contact each of the anode electrode and the cathode electrode, and a power supply port electrically connected to the metal frame to supply electric power of a high frequency to the metal frame. The electrode includes a reduced thickness portion in a predetermined concentratedly heated region.

### BACKGROUND OF THE INVENTION

### 1. Field of the Invention

The present invention relates to a solid oxide fuel cell.

### 2. Description of the Related Art

A solid oxide fuel cell (SOFC) is a fuel cell in which a cell is formed by sandwiching an electrolyte ceramic between an anode layer and a cathode layer. The SOFC has a high operating temperature, and it is necessary to heat an internal structure (such as a cell) to near 700° C. in order to start power generation.

Conventionally, as a method of heating the SOFC, a heating method of heating an external structure (such as a housing) using a gas burner or the like is known. However, in the heating method using the gas burner, since the internal structure is indirectly warmed by using heat applied to the external structure, heating efficiency is low, and a long time and a large amount of energy are required until the internal structure reaches a target temperature (operating temperature). Further, in the heating method using the gas burner, emissions such as NOx (nitrogen oxides) are generated.

Therefore, conventionally, a method of heating a power generator (cell) of an SOFC by irradiating the power generator with microwaves has been proposed (for example, see Japanese Unexamined Patent Publication No. 2011-165516). According to this heating method using microwaves, the generation of emissions such as NOx (nitrogen oxides) is suppressed.

However, even with a conventional heating method using microwaves, sufficiently high heating efficiency cannot be achieved, and a long time and a large amount of energy are still required until the internal structure reaches the target temperature (operating temperature).

### SUMMARY OF THE INVENTION

Example embodiments of the present invention provide solid oxide fuel cells each achieving high heating efficiency and capable of raising the temperature of an internal structure to a target temperature (operating temperature) in a short time and with a small amount of energy.

An aspect of an example embodiment of the present invention is a solid oxide fuel cell, and the solid oxide fuel cell includes an electrode including an electrolyte ceramic, and an anode electrode and a cathode electrode sandwiching the electrolyte ceramic from both sides, a metal frame located around the electrode so as to sandwich the electrode from both sides and physically contacting with the anode electrode and the cathode electrode, and a power supply port electrically connected to the metal frame to supply electric power of a high frequency to the metal frame, and the electrode includes a reduced thickness portion in a predetermined concentratedly heated region.

Another aspect of an example embodiment of the present invention is a solid oxide fuel cell, and the solid oxide fuel cell includes an electrode including an electrolyte ceramic, and an anode electrode and a cathode electrode sandwiching the electrolyte ceramic from both sides, a metal frame located around the electrode so as to sandwich the electrode from both sides and physical contacting with the anode electrode and the cathode electrode, and a power supply port electrically connected to the metal frame to supply electric power of a high frequency to the metal frame, and the anode electrode and the cathode electrode each have a mesh structure, and a mesh density of the mesh structure in a predetermined concentratedly heated region is higher than a mesh density of the mesh structure in a region other than the concentratedly heated region.

As will be described below, there are other aspects of example embodiments of the present invention. Therefore, the disclosure of the present invention is intended to provide some aspects of example embodiments of the present invention and is not intended to limit the scope of the present invention as described and claimed herein.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an explanatory view illustrating a configuration of a solid oxide fuel cell according to a first example embodiment of the present invention.

FIG. 2 is a perspective view of a main part of the solid oxide fuel cell according to the first example embodiment of the present invention.

FIG. 3 is a schematic view illustrating an example of the solid oxide fuel cell according to the first example embodiment of the present invention (an example in which a central portion of an electrode is a concentratedly heated region).

FIG. 4 is a schematic view illustrating another example of the solid oxide fuel cell according to the first example embodiment of the present invention (an example in which outer side portions of an electrode each are a concentratedly heated region).

FIG. 5 is a schematic view illustrating an example of a solid oxide fuel cell according to a second example embodiment of the present invention (an example in which a central portion of an electrode is a concentratedly heated region).

FIG. 6 is a schematic view illustrating another example of the solid oxide fuel cell according to the second example embodiment of the present invention (an example in which outer side portions of the electrode each are a concentratedly heated region).

FIG. 7 is an explanatory view illustrating a configuration of a solid oxide fuel cell according to a third example embodiment of the present invention.

FIG. 8 is an explanatory view illustrating a configuration of a solid oxide fuel cell according to a fourth example embodiment of the present invention.

FIG. 9 is an explanatory view illustrating a configuration of a solid oxide fuel cell according to a fifth example embodiment of the present invention.

### DETAILED DESCRIPTION OF THE EXAMPLE EMBODIMENTS

The present invention is described in detail below. However, the following detailed description and accompanying drawings are not intended to limit the invention.

A solid oxide fuel cell according to an example embodiment of the present invention includes an electrode including an electrolyte ceramic, and an anode electrode and a cathode electrode sandwiching the electrolyte ceramic from both sides, a metal frame located around the electrode so as to sandwich the electrode from both sides and physical contacting with the anode electrode and the cathode electrode, and a power supply port electrically connected to the metal frame to supply electric power of a high frequency to the metal frame, and the electrode includes a reduced thickness portion in a predetermined concentratedly heated region.

According to this configuration, when electric power is supplied from the power supply port to the metal frame around the electrode, the high frequency is directly supplied to the electrode through the metal frame, and the electrode is heated by the supplied high frequency. In this case, since the internal structure is directly warmed by using the high frequency applied to the internal structure (electrode), the heating efficiency is higher, and the temperature of the internal structure can be raised to the target temperature (operating temperature) in a short time with a small amount of energy.

In addition, since the electrode includes a reduced thickness portion at the predetermined concentratedly heated region, it is possible to concentrate the electric field to the region including the reduced thickness portion (concentratedly heated region) and the concentrated heating can be performed. For example, when the thickness of the central portion of the electrode is thinned to include a reduced thickness portion (a concentratedly heated region is provided in the central portion of the electrode), it is possible to concentratedly heat the central portion of the electrode to a high temperature. In addition, when the thickness of the outer side portion of the electrode is thinned to include a reduced thickness portion (a concentratedly heated region is provided in the outer side portion of the electrode), it is possible to concentratedly heat the outer side portion of the electrode to a high temperature. The thickness of the electrode may be adjusted by changing the thickness of any one material or a plurality of materials of the electrolyte ceramic, the anode electrode, and the cathode electrode.

Further, in a solid oxide fuel cell according to an example embodiment of the present invention, the predetermined concentratedly heated region may be a region preset as a region where heating efficiency is lower within a region of the electrode.

According to this configuration, for example, when a region where a heating effect is higher is partially generated under conditions such as the mechanical structure of the electrode and the metal frame and the frequency of the high-frequency that supplies electric power, the electrode can be uniformly heated by thinning the thickness of a region where the heating effect is lower. The heating efficiency of the electrode is measured in advance, and the concentratedly heated region can be preset based on the measurement result.

In a solid oxide fuel cell according to an example embodiment of the present invention, the anode electrode and the cathode electrode may each have a mesh structure, and a mesh density of the mesh structure in the predetermined concentratedly heated region may be higher than a mesh density of the mesh structure in a region other than the concentratedly heated region.

According to this configuration, since the mesh density of the mesh structure of the anode electrode and the cathode electrode is higher in the predetermined concentratedly heated region, it is possible to concentrate the electric field to the region where the mesh density is higher (concentratedly heated region), and to perform concentrated heating. For example, when the mesh density of the central portion of the electrode is increased (a concentratedly heated region is provided in the central portion of the electrode), it is possible to concentratedly heat the central portion of the electrode to a high temperature. In addition, when the mesh density of the outer side portion of the electrode is increased (the concentratedly heated region is provided in the outer side portion of the electrode), it is possible to concentratedly heat the outer side portion of the electrode to a high temperature.

In addition, for example, when a region where a heating effect is higher is partially generated under conditions such as the mechanical structure of the electrode and the metal frame and the frequency of the high-frequency that supplies electric power, the electrode can be uniformly heated by increasing the mesh density of a region where the heating effect is lower.

Further, in a solid oxide fuel cell according to an example embodiment of the present invention, the high frequency oscillator that generates the high frequency may include an electric power controller configured or programmed to control the power of the high frequency to be supplied to the power supply port in accordance with the temperature of the electrode.

According to this configuration, the electric power of the high frequency supplied to the power supply port is controlled in accordance with the temperature of the electrode. When the temperature of the electrode is increased, less electric power of the high frequency is required to be supplied to the power supply port (as compared with a case where the temperature of the electrode is lower). Therefore, by lessening the electric power of the high frequency supplied to the power supply port as the temperature of the electrode increases, the electric power of the high frequency to be supplied can be reduced in total.

Further, a solid oxide fuel cell according to an example embodiment of the present invention may include a pulse-driving controller configured or programmed to cause a high frequency oscillator that generates the high frequency to perform pulse- driving on a time axis.

According to this configuration, the high frequency oscillator is controlled to perform pulse-driving (under pulse-driving control) on the time axis. Even when the high frequency oscillator is subjected to pulse-driving control (for example, ON/OFF control), the temperature of the electrode can be sufficiently increased by setting the duty ratio of the ON/OFF control such that the temperature increase during the ON time exceeds the temperature decrease during the OFF time. During the ON control, the high frequency is supplied to the power supply port, while during the OFF control, the high frequency is not supplied to the power supply port. Therefore, the electric power of the high frequency to be supplied can be reduced in total. Further, even when the position of a cell to be heated is offset, the temperature of the cell is diffused during the OFF time, and the temperature of the cell can be made uniform. Further, since the continuous operation time of the high frequency oscillator is reduced, the life of the high frequency oscillator can be extended.

Further, a solid oxide fuel cell according to an example embodiment of the present invention may include a switch circuit to switch a supply destination of the electric power of the high frequency to be supplied to the power supply port from the high frequency oscillator to a power supply port of another solid oxide fuel cell, and a switch driving controller configured or programmed to switch the switch circuit.

According to this configuration, the supply destination of the high frequency supplied from the high frequency oscillator to the power supply port can be switched to the power supply port of another solid oxide fuel cell by controlling the switch circuit using the switch driving controller. This makes it possible to continuously supply high frequencies from one high frequency oscillator to the power supply ports of a plurality of solid oxide fuel cells on the time axis. For example, the duty ratio of the switch driving control may be varied in accordance with a temperature difference between the electrodes of the respective solid oxide fuel cells. The duty ratio of the switch driving control may also vary in accordance with the ratio of the physical sizes of the respective solid oxide fuel cells.

A solid oxide fuel cell according to an example embodiment of the present invention includes an electrode including an electrolyte ceramic, and an anode electrode and a cathode electrode sandwiching the electrolyte ceramic from both sides, a metal frame located around the electrode so as to sandwich the electrode from both sides and physically contacting with the anode electrode and the cathode electrode, and a power supply port electrically connected to the metal frame to supply electric power of a high frequency to the metal frame, and the anode electrode and the cathode electrode each have a mesh structure, and a mesh density of the mesh structure in a predetermined concentratedly heated region is higher than a mesh density of the mesh structure in a region other than the concentratedly heated region.

According to this configuration, when electric power is supplied from the power supply port to the metal frame around the electrode, the high frequency is directly supplied to the electrode through the metal frame, and the electrode is heated by the supplied high frequency. In this case, since the internal structure is directly warmed by using the high frequency applied to the internal structure (electrode), the heating efficiency is higher, and the temperature of the internal structure can be raised to the target temperature (operating temperature) in a short time with a small amount of energy.

In addition, since the mesh density of the mesh structure of the anode electrode and the cathode electrode is higher in the predetermined concentratedly heated region, it is possible to concentrate the electric field to the region where the mesh density is higher (concentratedly heated region), and to perform concentrated heating. For example, when the mesh density of the central portion of the electrode is increased (a concentratedly heated region is provided in the central portion of the electrode), it is possible to concentratedly heat the central portion of the electrode to a high temperature. In addition, when the mesh density of the outer side portion of the electrode is increased (the concentratedly heated region is provided in the outer side portion of the electrode), it is possible to concentratedly heat the outer side portion of the electrode to a high temperature.

In a solid oxide fuel cell according to an example embodiment of the present invention, the predetermined concentratedly heated region may be a region preset as a region where heating efficiency is lower within a region of the electrode.

According to this configuration, for example, when a region where a heating effect is higher is partially generated under conditions such as the mechanical structure of the electrode and the metal frame and the frequency of the high-frequency that supplies electric power, the electrode can be uniformly heated by increasing the mesh density of a region where the heating effect is lower. The heating efficiency of the electrode is measured in advance, and the concentratedly heated region can be preset based on the measurement result.

According to example embodiments of the present invention, the heating efficiency is higher, and the temperature of the internal structure can be raised to the target temperature (operating temperature) in a short time with a small amount of energy.

Hereinafter, a solid oxide fuel cell according to an example embodiment of the present invention will be described with reference to the drawings. In this example embodiment, the case of a solid oxide fuel cell used for an electronic device, an electric vehicle, or the like will be described.

### First Example Embodiment

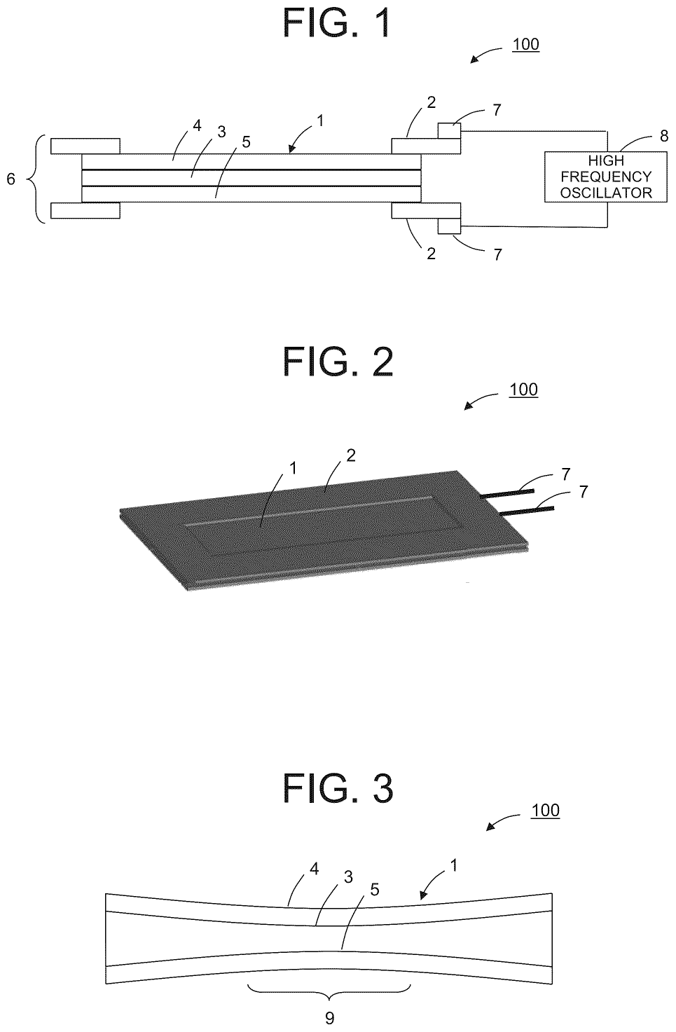

A configuration of a solid oxide fuel cell according to the first example embodiment of the present invention will be described with reference to the drawings. FIG. 1 is an explanatory view illustrating a configuration of a solid oxide fuel cell according to the present example embodiment, and FIG. 2 is a perspective view of a main portion of the solid oxide fuel cell according to the present example embodiment.

As illustrated in FIGS. 1 and 2, a solid oxide fuel cell 100 of the present example embodiment includes a plate-shaped electrode 1 and plate-shaped metal frames 2 positioned so as to sandwich the electrode 1 from both sides (both upper and lower sides in FIG. 1). The metal frames 2 each have an opening in the center (see FIG. 2). The electrode 1 includes a plate-shaped electrolyte ceramic 3 (dielectric), and an anode electrode 4 and a cathode electrode 5 that sandwich the electrolyte ceramic 3 from both sides (both upper and lower sides in FIG. 1). In other words, the electrode 1 and the metal frames 2 define a cell unit 6 (cell configuration).

The metal frames 2 are in physical contact with the anode electrode 4 and the cathode electrode 5. In the example of FIG. 1, a metal frame 2 on an upper side is in physical contact with the anode electrode 4, and a metal frame 2 on a lower side is in physical contact with the cathode electrode 5. A power supply port 7 is electrically connected to the metal frame 2. A high frequency oscillator 8 is electrically connected to the power supply port 7, and electric power of a high frequency (e.g., microwave) is supplied from the power supply port 7 to the metal frame 2.

In the solid oxide fuel cell 100 of the present example embodiment, a thickness of the electrode 1 is configured to be thinned to define a reduced thickness portion in a predetermined concentratedly heated region. The concentratedly heated region is a region preset as a region where heating efficiency is lower within a region of the electrode 1.

For example, in the example of FIG. 3, a concentratedly heated region is set at a central portion 9 of the electrode 1. In this example, the thickness of the electrode 1 (the sum of the thicknesses of the anode electrode 4, the cathode electrode 5, and the electrolyte ceramic 3) is about 550 μm at the thinnest position (the reduced thickness portion preferably located at a central position of the central portion 9) and about 600 μm at the thickest position (the outermost end position of the electrode 1). In this way, the thickness of the electrode 1 is configured to be thinned at the central portion 9 (concentratedly heated region) to define a reduced thickness portion. More specifically, the thickness of the anode electrode 4 at the thinnest position of the central portion 9 of the electrode 1 is about 426 μm, which is configured to be thinner than the outermost end of the electrode 1 (the thickness of the anode electrode 4 is about 476 μm). In addition, the thicknesses of the cathode electrode 5 and the electrolyte ceramic are constant or substantially constant (for example, the thickness of the cathode electrode 5 is about 120 μm, and the thickness of the electrolyte ceramic is about 4 μm).

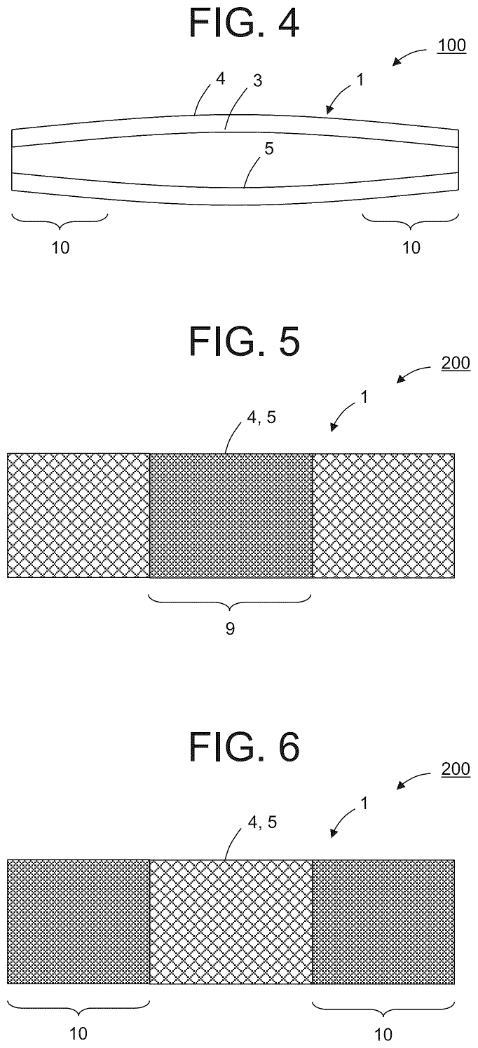

Further, in the example of FIG. 4, a concentratedly heated region is set at an outer side portion 10 of the electrode 1. In this example, the thickness of the electrode 1 (the sum of the thicknesses of the anode electrode 4, the cathode electrode 5, and the electrolyte ceramic 3) is about 550 μm at the thinnest position (the outermost end position of the outer side portion 10) and about 600 μm at the thickest position (the center position of the electrode 1). In this way, the thickness of the electrode 1 is configured to be thinned at the outer side portion 10 (concentratedly heated region) to define a reduced thickness portion. More specifically, the thickness of the anode electrode 4 at the thinnest position of the outer side portion 10 of the electrode 1 is about 426 μm, which is configured to be thinner than the center of the electrode 1 (for example, the thickness of the anode electrode 4 is about 476 μm), for example. In addition, the thicknesses of the cathode electrode 5 and the electrolyte ceramic are constant or substantially constant (for example, the thickness of the cathode electrode 5 is about 120 μm, and the thickness of the electrolyte ceramic is about 4 μm).

The size of the anode electrode 4 and the size of the cathode electrode 5 are set to be larger than the size of the electrolyte ceramic 3. For example, the size of the anode electrode 4 and the size of the cathode electrode 5 each are about 50. 4 mm in length and about 23.7 mm in width, and the size of the electrolyte ceramic 3 is about 49.6 mm in length and about 19.8 mm in width. Further, the size of the metal frame 2 is set to be larger than the size of the anode electrode 4 and the size of the cathode electrode 5, and the size of the opening of the metal frame 2 is set to be smaller than the size of the anode electrode 4 and the size of the cathode electrode 5. For example, the size of the metal frame 2 is about 65 mm in length and about 41 mm in width, and the size of the opening of the metal frame 2 is about 48 mm in length and about 18 mm in width.

The sizes of the anode electrode 4, the electrolyte ceramic 3, and the cathode electrode 5 are not limited to those described above. For example, the size of the anode electrode 4 may be about 53.5 mm in length and about 23.5 mm in width, the size of the electrolyte ceramic 3 may be about 53.5 mm in length and about 23.5 mm in width, and the size of the cathode electrode 5 may be about 50 mm in length and about 20 mm in width.

As a material of the anode electrode 4, for example, nickel oxide (NiO) or the like is used, and as a material of the cathode electrode 5, for example, lanthanum strontium cobalt ferrite (LSCF), lanthanum strontium manganite (LSM), or the like is used. In addition, as the material of the electrolyte ceramic 3, for example, yttria stabilized zirconia (YSZ), gadolinium doped ceria (GDC) or the like is used, and as the material of the metal frame 2, for example, steel use stainless (SUS) or the like is used.

According to the solid oxide fuel cell 100 of the first example embodiment of the present invention, when electric power is supplied from the power supply port 7 to the metal frame 2 disposed around the electrode 1, a high frequency is directly supplied to the electrode 1 through the metal frame 2, and the electrode 1 is heated by the supplied high frequency. In this case, since the internal structure is directly warmed by using the high frequency applied to the internal structure (electrode 1), the heating efficiency is higher, and the temperature of the internal structure can be raised to the target temperature (operating temperature) in a short time and with a small amount of energy.

In addition, since the thickness of the electrode 1 is configured to be thinned at the predetermined concentratedly heated region to define a reduced thickness portion, it is possible to concentrate the electric field to the region including the reduced thickness portion (concentratedly heated region) and the concentrated heating can be performed. For example, when the thickness of the central portion 9 of the electrode 1 is thinned (a concentratedly heated region is provided in the central portion 9 of the electrode 1) to provide the reduced thickness portion, it is possible to concentratedly heat the central portion 9 of the electrode 1 to a high temperature. In addition, when the thickness of the outer side portion 10 of the electrode 1 is thinned (a concentratedly heated region is provided in the outer side portion 10 of the electrode) to provide the reduced thickness portion, it is possible to concentratedly heat the outer side portion 10 of the electrode 1 to a high temperature. The thickness of the electrode 1 may be adjusted by changing the thickness of any one or a plurality of materials of the electrolyte ceramic 3, the anode electrode 4, and the cathode electrode 5.

In this case, for example, when a region where a heating effect is higher is partially generated under conditions such as the mechanical structure of the electrode 1 and the metal frame 2 and the frequency of the high-frequency that supplies electric power, the electrode 1 can be uniformly heated by thinning the thickness of a region where the heating effect is lower to provide the reduced thickness portion. The heating efficiency of the electrode 1 is measured in advance, and the concentratedly heated region can be preset based on the measurement result.

### Second Example Embodiment

Next, a solid oxide fuel cell according to the second example embodiment of the present invention will be described. Here, differences between the solid oxide fuel cell of the second example embodiment and that of the first example embodiment will be mainly described. Unless otherwise specified, the configuration and operation of the present example embodiment are the same as those of the first example embodiment.

In the solid oxide fuel cell 200 of the present example embodiment, the anode electrode 4 and the cathode electrode 5 each have a mesh structure, and the mesh density of the mesh structure in the concentratedly heated region is configured to be higher than a mesh density of the mesh structure in a region other than the concentratedly heated region.

For example, in the example of FIG. 5, a concentratedly heated region is set at the central portion 9 of the electrode 1. In this example, the mesh density of the mesh structure of the anode electrode 4 and the cathode electrode 5 at the central portion 9 of the electrode 1 is about 30 m/s, which is configured to be higher than the mesh density at the outermost end of the electrode 1 (mesh density (about 20 m/s) of the mesh structure of the anode electrode 4 and cathode electrode 5).

Further, in the example of FIG. 6, a concentratedly heated region is set at the outer side portion 10 of the electrode 1. In this example, the mesh density of the mesh structure of the anode electrode 4 and the cathode electrode 5 at the outer side portion 10 of the electrode 1 is about 30 m/s, which is configured to be higher than the mesh density at the center of the electrode 1 (mesh density (about 20 m/s) of the mesh structure of the anode electrode 4 and cathode electrode 5).

According to the solid oxide fuel cell 200 of the second example embodiment of the present invention, the same effects as those of the first example embodiment can be obtained.

In the present example embodiment, since the mesh density of the mesh structure of the anode electrode 4 and the cathode electrode 5 is configured to be higher in the predetermined concentratedly heated region, it is possible to concentrate the electric field to the region where the mesh density is higher (concentratedly heated region), and to perform concentrated heating. For example, when the mesh density of the central portion 9 of the electrode 1 is increased (a concentratedly heated region is provided in the central portion 9 of the electrode 1), it is possible to concentratedly the central portion 9 of the electrode 1 to a high temperature. In addition, when the mesh density of the outer side portion 10 of the electrode 1 is increased (the concentratedly heated region is provided in the outer side portion 10 of the electrode 1), it is possible to concentratedly heat the outer side portion 10 of the electrode 1 to a high temperature.

In this case, for example, when a region where a heating effect is higher is partially generated under conditions such as the mechanical structure of the electrode 1 and the metal frame 2 and the frequency of the high-frequency that supplies electric power, the electrode 1 can be uniformly heated by increasing the mesh density of a region where the heating effect is lower. The heating efficiency of the electrode 1 is measured in advance, and the concentratedly heated region can be preset based on the measurement result.

Note that the first example embodiment and the second example embodiment may be combined. That is, the thickness of the electrode 1 may be configured to be thinned in a predetermined concentratedly heated region to provide a reduced thickness portion, and the anode electrode 4 and the cathode electrode 5 may be configured to have a mesh structure such that the mesh density of the mesh structure in the concentratedly heated region is higher than the mesh density of the mesh structure in a region other than the concentratedly heated region.

### Third Example Embodiment

Next, a solid oxide fuel cell according to the third example embodiment of the present invention will be described. Here, differences between the solid oxide fuel cell of the third example embodiment and that of the first example embodiment will be mainly described. Unless otherwise specified, the configuration and operation of the present example embodiment are the same as those of the first example embodiment.

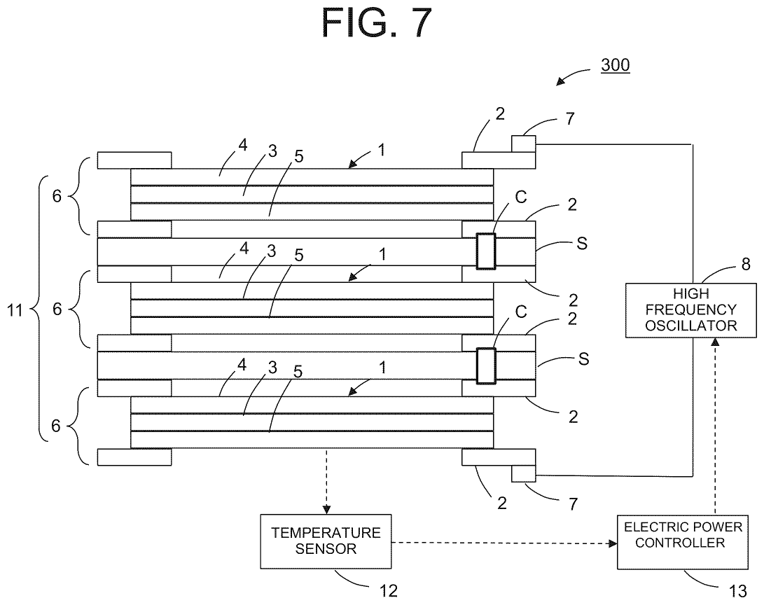

FIG. 7 is an explanatory view illustrating the configuration of the solid oxide fuel cell of the present example embodiment. As illustrated in FIG. 7, in the solid oxide fuel cell 300 of the present example embodiment, a plurality of cell units 6 are arranged in series and electrically connected to each other. A separator S for gas is disposed between the cell units 6. The separator S is made of, for example, mica. Even in the case where the separator S is provided between the cell unit 6 and the cell unit 6, the metal frame 2 of the cell unit 6 and the metal frame 2 of the cell unit 6 are electrically connected to each other via a connection portion C (see FIG. 7). For example, the same material (metal) as the metal frame 2 can be used as the material of the connection portion C.

It can also be said that in the solid oxide fuel cell 300 of the present example embodiment, the plurality of cell units 6 are stacked (layered) to define one stack unit 11 (stack configuration). The power supply port 7 is electrically connected to the metal frame 2 disposed on the outermost side (the uppermost side and the lowermost side in FIG. 7) among the metal frames 2 of the plurality of cell units 6, and the electric power of the high frequency is supplied from the power supply port 7 to the metal frame 2 disposed on the outermost side.

In addition, as illustrated in FIG. 7, the solid oxide fuel cell 300 of the present example embodiment includes a temperature sensor 12 that measures the temperature of the electrode 1, and an electric power controller 13 configured or programmed to control the electric power of the high frequency to be supplied to the power supply port 7 in accordance with the temperature of the electrode 1. For example, even when the electrode 1 is heated up to about 700° C., required electric power of a high frequency differs between a case of heating from room temperature (about 25° C.) and a case of heating from about 400° C. Therefore, the temperature of the electrode 1 is measured by a temperature sensor 12, and the output power of the high frequency oscillator 8 is controlled by the electric power controller 13 according to the measured temperature. For example, when the temperature of the electrode 1 is lower, the output power of the high frequency oscillator 8 is increased, and when the temperature of the electrode 1 is higher, the output power of the high frequency oscillator 8 is decreased.

According to the solid oxide fuel cell 300 of the third example embodiment of the present invention, the same effects as those of the first example embodiment can be obtained.

Moreover, in the present example embodiment, the electric power of the high frequency supplied to the power supply port 7 is controlled in accordance with the temperature of the electrode 1. When the temperature of the electrode 1 is increased, less electric power of the high frequency is required to be supplied to the power supply port 7 (as compared with a case where the temperature of the electrode 1 is lower). Therefore, by lessening the electric power of the high frequency supplied to the power supply port 7 as the temperature of the electrode 1 increases, the electric power of the high frequency to be supplied can be reduced in total. As a result, the solid oxide fuel cell 300 can be started up efficiently and quickly with minimum required electric power.

Further, in this example embodiment, the plurality of electrodes 1 arranged in series are electrically connected to each other via the metal frame 2 and the connection portion C, and these electrodes 1 can be regarded as a series connection of capacitors in terms of an electric circuit. Therefore, by supplying electric power from the power supply port 7 to the metal frame 2 disposed on the outermost side, the electric power of the high frequency can be uniformly supplied to all the electrodes 1.

### Fourth Example Embodiment

Next, a solid oxide fuel cell according to the fourth example embodiment of the present invention will be described. Here, differences between the solid oxide fuel cell of the fourth example embodiment and that of the third example embodiment will be mainly described. Unless otherwise specified, the configuration and operation of the present example embodiment are the same as those of the third example embodiment.

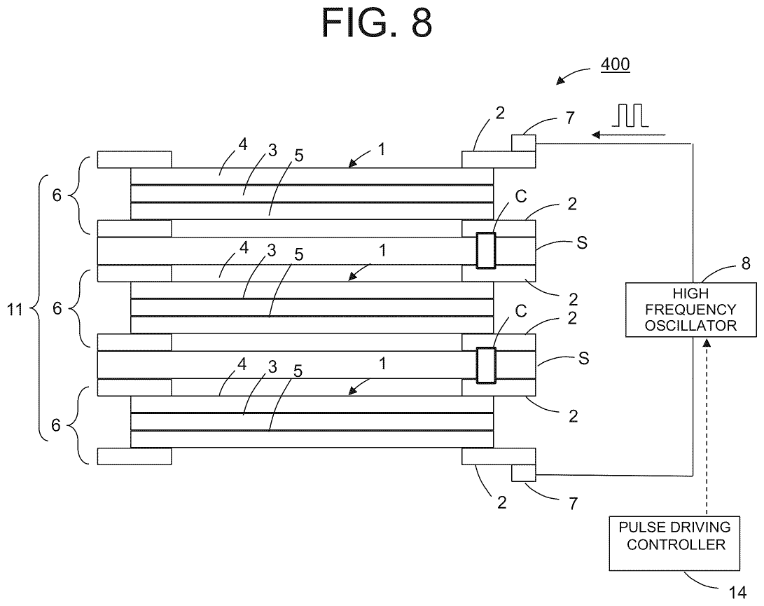

FIG. 8 is an explanatory view illustrating the configuration of the solid oxide fuel cell of the present example embodiment. As illustrated in FIG. 8, the solid oxide fuel cell 400 of the present example embodiment includes a pulse-driving controller 14 configured or programmed to cause the high frequency oscillator 8 to perform pulse-driving on a time axis. When the solid oxide fuel cell 400 is heated to a predetermined target temperature (for example, about 700° C.), the pulse-driving controller 14 is configured or programmed to control ON/OFF of the high frequency oscillator 8 at a constant time cycle (for example, a cycle of about 60 seconds).

According to the solid oxide fuel cell 400 of the fourth example embodiment of the present invention, the same effects as those of the first example embodiment can be obtained.

In addition, in the present example embodiment, the high frequency oscillator 8 is controlled to perform pulse-driving (under pulse-driving control) on the time axis. Even when the high frequency oscillator 8 is subjected to pulse-driving control (for example, ON/OFF control), the temperature of the electrode 1 can be sufficiently increased by setting the duty ratio of the ON/OFF control such that the temperature increase during the ON time exceeds the temperature decrease during the OFF time. During the ON control, the high frequency is supplied to the power supply port 7, while during the OFF control, the high frequency is not supplied to the power supply port 7. Therefore, the electric power of the high frequency to be supplied can be reduced in total. Further, even when the position of a cell to be heated is offset, the temperature of the cell is diffused during the OFF time, and the temperature of the cell can be made uniform. Further, since the continuous operation time of the high frequency oscillator 8 is reduced, the life of the high frequency oscillator 8 can be extended.

### Fifth Example Embodiment

Next, a solid oxide fuel cell according to the fifth example embodiment of the present invention will be described. Here, differences between the solid oxide fuel cell of the fifth example embodiment and that of the third example embodiment will be mainly described. Unless otherwise specified, the configuration and operation of the present example embodiment are the same as those of the third example embodiment.

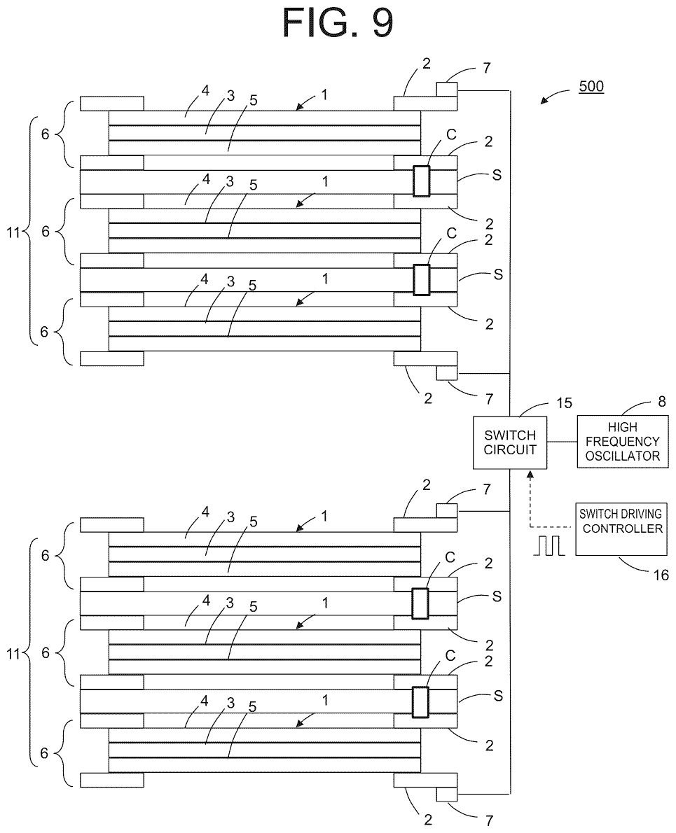

FIG. 9 is an explanatory view illustrating a configuration of the solid oxide fuel cell of the present example embodiment. As illustrated in FIG. 9, the solid oxide fuel cell 500 of the present example embodiment is provided with a plurality of (two in the example of FIG. 9) stack units 11 as the supply destination of the high frequency. The solid oxide fuel cell 500 of the present example embodiment includes a switch circuit 15 to switch the supply destination of the high frequency, and a switch driving controller 16 configured or programmed to switch the switch circuit 15.

The switch driving controller 16 is configured or programmed to control the switch circuit 15 so as to switch the supply destination of the high frequency at a constant time cycle (for example, a cycle of about 60 seconds). For example, in the example of FIG. 9, the switch circuit 15 is controlled to supply electric power of a high frequency from the high frequency oscillator 8 to the power supply port 7 of one stack unit 11 (an upper stack unit 11 in FIG. 9) for a certain period of time (for example, about 60 seconds), and to supply electric power of a high frequency from the high frequency oscillator 8 to the power supply port 7 of another stack unit 11 (a lower stack unit 11 in FIG. 9) for the next certain period of time (for example, 60 seconds).

According to the solid oxide fuel cell 500 of the fifth example embodiment of the present invention, the same effects as those of the first example embodiment can be obtained. In addition, in the present example embodiment, the supply destination of the high frequency supplied from the high frequency oscillator 8 to the power supply port 7 is switched to the power supply port 7 of another solid oxide fuel cell (stack unit 11) by controlling the switch circuit 15 using the switch driving controller 16. As a result, it is possible to continuously supply the high frequency from one high frequency oscillator 8 to the power supply ports 7 of the plurality of solid oxide fuel cells (stack units 11) on the time axis. For example, the duty ratio of the switch driving control may be varied in accordance with a temperature difference between the electrodes 1 of the respective solid oxide fuel cells (stack units 11). The duty ratio of the switch driving control may also vary in accordance with the ratio of the physical sizes of the respective solid oxide fuel cells (stack units 11).

### INDUSTRIAL APPLICABILITY

As described above, the solid oxide fuel cell according to the present invention has the effects that the heating efficiency is higher and the temperature of the internal structure can be raised to the target temperature (operating temperature) in a short time with a small amount of energy, and is useful for use in electronic devices, electric vehicles, or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A solid oxide fuel cell comprising:
an electrode including an electrolyte ceramic, and an anode electrode and a cathode electrode sandwiching the electrolyte ceramic from both sides;
a metal frame located around the electrode so as to sandwich the electrode from both sides and physical contacting with the anode electrode and the cathode electrode; and
a power supply port electrically connected to the metal frame to supply electric power of a high frequency to the metal frame; wherein
the electrode includes a reduced thickness portion in a predetermined concentratedly heated region.

10. The solid oxide fuel cell according to claim 9, wherein the predetermined concentratedly heated region is a region preset as a region where heating efficiency is reduced within a region of the electrode.

11. The solid oxide fuel cell according to claim 9, wherein
the anode electrode and the cathode electrode each have a mesh structure; and
a mesh density of the mesh structure in the predetermined concentratedly heated region is higher than a mesh density of the mesh structure in a region other than the concentratedly heated region.

12. The solid oxide fuel cell according to claim 9, wherein a high frequency oscillator to generate the high frequency includes an electric power controller configured or programmed to control electric power of a high frequency to be supplied to the power supply port in accordance with a temperature of the electrode.

13. The solid oxide fuel cell according to claim 9, further comprising a pulse-driving controller configured or programmed to cause a high frequency oscillator that generates the high frequency to perform pulse-driving on a time axis.

14. The solid oxide fuel cell according to claim 13, further comprising a switch circuit to switch a supply destination of the electric power of the high frequency to be supplied to the power supply port from the high frequency oscillator to a power supply port of another solid oxide fuel cell, and a switch driving controller configured or programmed to switch the switch circuit.

15. A solid oxide fuel cell comprising:
an electrode including an electrolyte ceramic, and an anode electrode and a cathode electrode sandwiching the electrolyte ceramic from both sides;
a metal frame located around the electrode so as to sandwich the electrode from both sides and physically contacting with the anode electrode and the cathode electrode; and
a power supply port electrically connected to the metal frame to supply electric power of a high frequency to the metal frame; wherein
the anode electrode and the cathode electrode each have a mesh structure; and
a mesh density of the mesh structure in a predetermined concentratedly heated region is higher than a mesh density of the mesh structure in a region other than the concentratedly heated region.

16. The solid oxide fuel cell according to claim 15, wherein the predetermined concentratedly heated region is a region preset as a region where heating efficiency is reduced within a region of the electrode.
